(19) United States
(12) Patent Application Publication
(10) Pub. No.: US 2005/0137754 A1
(43) Pub. Date: Jun. 23, 2005

(54) Transportation notification, emergency response, and surveillance system

(76) Inventor: Alan Leigh Bartlett, New Braunfels, TX (US)

Correspondence Address: Alan L. Bartlett, 4415 River Oaks, New Braunfels, TX, 78132, US

(21) Appl. No.: 10/855,001

(22) Filed: Oct. 17, 2003

Related U.S. Application Data
(60) Provisional application No. 60/419,889, filed on Oct. 21, 2002.

(51) Int. Cl. G06F 7/00

(52) U.S. Cl. 701/1; 701/300; 340/464

(57) ABSTRACT

A system for patrons of public transportation waiting at transit stops, to provide data to transit vehicles serving these stops, that identifies which transit vehicles are desired, and the transit stop locations corresponding to the data. The system includes methodology for transit vehicles that received the data, to provide acknowledgements to the patrons of having received their requests. The system includes a powered transit stop with attachments for wireless communication, an input panel for selecting transit routes, a display device, a video camera, a signaling device and a processor to control interactions of attached devices. The transit stop processor stores patron requests and the physical address of the transit stop, and uses wireless communication links with the mass transit vehicles to upload the stored data to displays located in mass transit vehicles when they query the transit stop. Communication display modules having storage of the selective call numbers for the transit stops are included on the mass transit vehicles. In addition passive means are included to enable drivers of mass transit vehicles to visually determine the location of transit stops having patrons waiting. The transit stop's processor and wireless communication have the added benefit of enabling people at transit stops to initiate an emergency notification call to emergency response centers(s) whose calling numbers are stored in the transit stop processor. The included video camera at the transit stop further provides a method for video images to be transmitted in addition to sound and location data, all of which can be used by the emergency response centers(s) called to facilitate the most appropriate response to emergency calls. An alternate configuration of the system described by the present invention provides an embodiment for patrons of private transportation to notify dispatchers of roving transit vehicles as to the locations from where they are seeking service. Capabilities are included at the transit stops, which the central dispatch facilities could utilize to acquire video images, in addition to data and sound, as a deterrent to possible crimes that might be perpetrated against their drivers or their patrons.

### RELATED APPLICATIONS

This Application claims the benefit of U.S. Provisional Patent Application Ser. No. 60/419,889 entitled TRANSPORTATION NOTIFICATION, EMERGENCY RESPONSE, AND SURVEILLANCE SYSTEM filed by Alan L. Bartlett on Oct. 21, 2002, which is herein incorporated by reference.

### FIELD OF THE INVENTION

This invention relates to systems providing interactive communication between transit patrons and providers of transit services. The invention further relates to emergency communication services analogous to 911. This invention also relates to security and surveillance systems, and an improved reflective signaling device.

### BACKGROUND

Note: In the descriptions to follow, patrons are defined as those person(s) desiring to utilize transit services, being differentiated from passenger(s) being those person(s) who are riding on transit vehicles. Mass transit is defined as those vehicles that follow generally prescribed routes such as buses, planes, boats and trains, while roving transit vehicles denote conveyances such as taxis, limousines, water taxis or chartered aircraft that provide “on demand services” and don't have rigorously defined routes and or schedules.

Heretofore mass transit systems such as that described by U.S. Pat. No. 6,374,176 utilize communication means to notify potential patrons when selected vehicles will arrive at selected stops, and teaches use of input devices to allow passengers to request services. However, this system describes only receivers at transit stops and thus does not acquire any notification from patrons waiting at transit stops relating to the locations of their stops and the transport routes from which they desire service. U.S. Pat. No. 6,374,176 describes use of a central computing system to dispatch transit vehicles, however, computers are known to fail and such failures of a central computer would disable the entire information network. U.S. Pat. No. 6,374,176 describes transit vehicles that use a global positioning system (GPS), in conjunction with stored tables to predict arrival times of transit vehicles at future stops. Arrival times calculated in this manner are known to lack precision due to being affected by many variables such as traffic delays, number of stops made, etc. Further, some users of transit systems, such as those not aware of the current time of day, would gain more useful information by knowing the times until arrival as opposed to the times of arrival, of their desired conveyances. U.S. Pat. No. 6,374,176 describes use of its communications system to allow passengers to signal a central processor of the need for service including emergency service. However the locations of these calls are described by U.S. Pat. No. 6,374,176 as being acquired from the GPS located on the transit vehicle from which the call originates, and no provision is described to independently transmit emergency request location data from transit stops independent of transit vehicles.

It is known in the art to provide an electrically powered signal structure at a transit stop capable of interacting with patrons, to generate an indication to drivers of mass transit vehicles that patrons are waiting for pickup.

U.S. Pat. No. 698,942 to Harrison, issued on Apr. 29, 1902, teaches a signaling device at a train station that automatically activates a signal (a light for use at night and a semaphore for use during the day) whenever a patron stands inside the station or on a platform outside the station. U.S. Pat. No. 743,789 to Wrenn, issued on Nov. 10, 1905, teaches another signaling device—a cluster of electric lights—at a train station that can be turned on by a prospective passenger, and later turned off by the passing car. Solar Outdoor Lighting of Boca Raton, Fla., has manufactured a solar-powered light source that can be activated by patrons at transit stops to provide illumination to the patrons and to signal approaching bus drivers. U.S. Pat. No. 6,621,177 to Westcott, issued on Sep. 16, 2003, teaches use of a flashing light activated by patrons at a self powered transit stop intended to signal an approaching bus driver. The disadvantages of these signaling methods is their dependence upon continued power to be supplied at their installed locations for night viewing, limitations as to the amount of power that can be supplied for signaling by a energy storage unit at self powered transit stop, the mechanical complexity of an operable semaphore used for signaling, and the difficulty of discerning a semaphore and its position when it is located among other devices in an urban environment, and the fact that if the day and night signaling means are used in a mutually exclusive fashion, then the signal will be ambiguous at twilight conditions.

### SUMMARY OF THE INVENTION

An object of the present invention is to eliminate system outage from failure of a central computer by providing a distributed information flow with direct communication between transit stops and transit vehicles.

Traditionally, mass transit patrons must locate themselves at designated transit stops where operators of conveyance vehicles approaching the transit stops can see them. Frequently several transit vehicles having different routes share some transit stops. Thus all transit vehicles must stop at every transit stop location having patrons waiting to determine if the patrons want their particular routes. An object of the present invention is to provide patrons at transit stops with a system capable of informing operators of mass transit conveyance vehicles of the locations where patrons are requesting transportation and which routes are desired. A further object is to provide patrons waiting at the transit stops confirmation that the targeted transit vehicles have received their requests.

An object of the present invention is to provide a capability for feedback from an approaching transit vehicle, to the transit stop of the patron having selected the transit vehicle's particular route, that the transit vehicle received notification that the patron is waiting, and the approximate amount of time before the transit vehicle will arrive at the patron's transit stop. With knowledge of how many and which intervening stops have to be serviced, estimates of times until arrivals can be reasonably estimated and communicated to the transit stops requesting service.

Inclement weather conditions frequently make it desirable for transit patrons to wait in sheltered areas, which are sometimes located near some transit stops. A further object of this invention is to provide short range communication between the transit shelters and their associated transit stops, to provide patrons in the shelters with interactive use of the transit stops input and output functions via redundant input and output devices located in the shelter. By utilizing this invention, mass transit patrons waiting in shelters, can have the assurance that their selected conveyance vehicles have knowledge that they are waiting. This affords the patrons with opportunities to better utilize the time waiting, by not having to stand at the transit stop and monitor approaching transit vehicles. By utilizing this invention transit vehicles can avoid stopping at locations having patrons waiting for vehicles of other routes and thus improve the efficiency of running their routes.

Some mass transit systems are already in place, which utilize a central computing system to communicate with transit vehicles within their system. A further object of this invention is to provide capabilities for the transit stops described in this invention to communicate through a central facility which communicates with the transit vehicles and thus provides an intermediate link between the transit stops and mass transit vehicles.

An additional object of the present invention is to improve transit system efficiencies by eliminating some stops on prescribed routes, through providing information to the system that includes both the locations of transit stops having patrons requesting service, and the particular routes desired by these patrons.

An object of the present invention is to provide patrons at designated transit stops served by roving transit vehicles such as taxis, with capabilities to communicate with their central dispatch facilities to inform them of the locations where patrons are seeking transportation. A further object of the present invention is to provide capabilities at the transit stops, which the central dispatch facilities could utilize to acquire video images, in addition to data and sound, from the calling locations, as a possible deterrent to crimes known to be perpetrated upon operators of these transit vehicles.

An object of the present invention is to provide drivers of mass transit vehicles, who have progressed to within line of sight of a transit stop, with means to determine if the transit stop has patrons waiting for pickup, said means not requiring any continuous power from the transit stop, and said means recognizable in both daylight and darkness.

Some callers seeking emergency service, such as children, or people speaking only foreign languages, may either not know, or not be able to communicate the exact location they are calling from. An object of this invention is to provide persons at transit stops with a capability to initiate an emergency call analogous to 911, that includes capability for two way voice, a prerecorded message describing the call as an emergency with verbalization of the location of the calls origin, video transmission from the transit stop and data indicative of the location of the calls origin.

Numerous scenarios can be envisioned whereby it would be useful for providers of mass transit to be able to obtain video images and sound from the transit stops served by their vehicles. Such capability could facilitate security, for instance if a patron requesting service was seen to be carrying a fire arm, law enforcement could be summoned. This capability would discourage vandalism of the transit stops, if potential vendors knew they could be seen and or heard. An object of the present invention is to provide capabilities at the transit stops, which the providers of mass transit service could utilize to acquire video images and sound, in addition to data, from transit stops.

An unexpected result of creating one of the elements of this invention was its potential use as an improved signaling device using reflected light. Common light reflectors as are normally used on such things as street signs, mailboxes, residential house numbers, bicycle fenders, running shoe heels, caution markers, toys, and Christmas Tree ornaments would be more obvious to viewers if they were blinking. The use of a light shuttering device in combination with a common light reflector as described by this invention results in a novel, low power, highly visible signaling device.

### BRIEF DESCRIPTION OF THE DRAWINGS

The accompanying drawings, which are incorporated in and constitute a part of this specification, diagrammatically illustrate a preferred embodiment of this invention, and together with the general description above and detailed description below serve to explain the principles of this invention.

FIG. 1 is a schematic diagram of a preferred embodiment of a transportation notification system including a solar powered transit stop, transit shelter, and transit vehicle, with communication links between the parts.

FIG. 2 is a block diagram of one embodiment of the control and display electronics of the transportation notification system.

FIG. 3 illustrates a transit stop with local communication to a transit shelter and distant communication to a facility that can both dispatch roving transit vehicles and monitor activity provided by a camera at the transit stop.

FIG. 4 illustrates a system integrating a transit stop and an emergency response center that can dispatch emergency vehicles.

FIG. 5 is a block diagram of another embodiment of the control and display electronics of the current invention deployed redundantly in a transit shelter and transit stop subsystem.

FIG. 6 is a block diagram of an alternate embodiment of the transit stop control processor, which includes a data link to a global positioning system, GPS, for acquiring location information.

FIG. 7 illustrates one embodiment of a shuttering system for blocking reflection of radiant energy from reaching a reflector at a transit stop, thereby signaling that no patrons have requested transit service at said stop.

FIG. 8 illustrates the shuttering system of FIG. 7 with the shutter opened, thereby signaling that patrons are waiting for transportations services.

FIG. 9 is a diagram of a signaling device comprising a light shutter and a reflector.

FIG. 10 depicts the signaling device of FIG. 9 with the shutter in the closed position.

### DETAILED DESCRIPTION

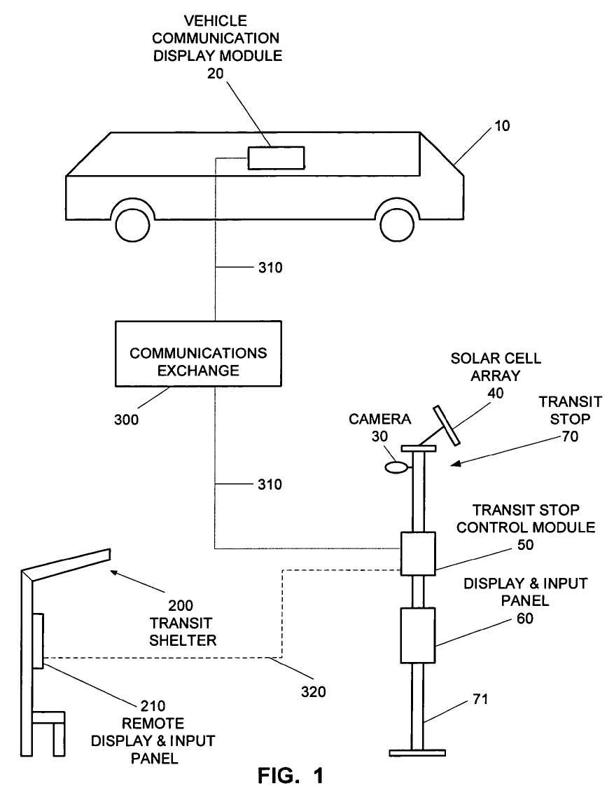

FIG. 1 depicts a preferred embodiment of the public transportation information system, which comprises a transit stop 70 communicatively coupled to a communications exchange 300 communicatively coupled to a mass transit vehicle 10. Transit stop 70 comprises a transit stop control module 50 powered by a solar cell array 40 and communicatively coupled to a user interface 60 and camera 30. The transit stop control module 50, camera 30, solar cell array 40, and user interface display and input panel 60 are supported by a support platform 71. The transit stop could also be supported by the support member of a display information apparatus incorporated herein by reference “Application No. 60/388/532, filing date Jun. 13, 2002. The transit stop control module 50 is optionally communicatively coupled via shelter communication link 320 to a remote display and input panel 210 mounted in a nearby transit shelter 200. Shelter communication link 320 preferably comprises low power wireless communications devices that utilize, for example, radio frequency carriers or infrared light signals. Alternatively, shelter communications link 320 comprises a wired connection. Also seen in FIG. 1 are mass transit vehicle 10, containing vehicle communication display module 20, and communications exchange 300, providing wireless connectivity between transit stop 70 and mass transit vehicle 10 by way of transit stop communication link 310. In the preferred embodiment, transit stop communication link 310 utilizes wireless phone technology, and communication exchange 300 includes one or more telephone exchanges that provide connectivity between the transit stop 70 and other locations. It will be appreciated, however, that alternate communications technologies may be used, such as radio transmissions and/or satellite links. Transit stop communication link 310 may also include an Internet connection, whereby communication exchange 300 would include both telephone exchanges and linkage through Internet service providers. Camera 30 is either a still camera, preferably of the digital variety, or a video camera operably connected to transit stop control module 50. In the preferred embodiment, solar cell array 40 supplies energy to transit stop 70. Commercial power, however, could be used as an alternate embodiment when it is available.

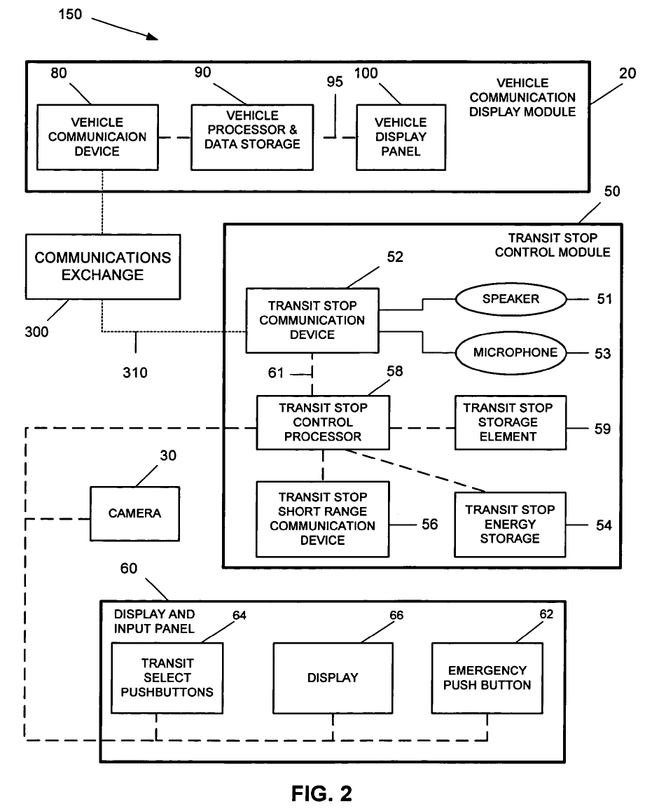

FIG. 2 illustrates one embodiment of the control and display electronics of the public transportation information system 150. The public transportation information system 150 comprises the transit stop control module 50, the user interface display and input panel 60, the communications exchange 300, and the vehicle communication display module 20. User interface display and input panel 60 comprises emergency pushbutton 62, transit select pushbuttons 64 and display 66. Transit stop control module 50 comprises transit stop communication device 52 with attached microphone input 53 and output speaker 51. Transit stop control module 50 further comprises transit stop energy storage 54, transit stop short range communication device 56, and transit stop control processor 58 with its attached transit stop storage element 59. Components of user interface 60 and transit stop control module 50 are interconnected by transit stop electrical connections 61. Vehicle communication control module 20 comprises vehicle communication device 80, vehicle processor & data storage 90, vehicle display panel 100 and vehicle communication display module electrical connections 95.

In the preferred embodiment, transit stop energy storage 54 comprises a rechargeable battery and charging components, electrically connected to solar cell array 40 previously seen in FIG. 1. In an alternate embodiment, where commercial power replaces solar cell array input, transit stop energy storage 54 comprises a power supply, which converts alternating current voltage to direct current voltage stored by capacitors.

In the preferred embodiment, vehicle communication device 80 and transit stop communication device 52 employ wireless phone technology to communicate. Alternate embodiments utilize other well-known communications methods, such as radio transmitters. In the preferred embodiment, communications devices 80 and 52 comprise modulator-demodulators (modems) of the type that communicates voice and data simultaneously, which are commonly referred to as DSVD modems.

In the preferred embodiment transit stop storage element 59 comprises semiconductor memory, but alternate embodiments are possible using magnetic media such as computer disks, or light storage devices such as compact disks (CDs).

In the preferred embodiment transit stop short range communication device 56 is implemented with low power radio frequency, however in alternate embodiments it could comprise light sending and receiving devices such as infrared transmitters and receivers, or it could be a directly wired connection.

In the preferred embodiment, pushbutton 62 initiates emergency calls, which activates a switch (not shown), however alternate embodiments could utilize mechanical devices such as a pull chain or lever to activate the switch.

In the preferred embodiment, display 66 comprises graphical display devices capable of displaying times until arrivals of transit vehicles, and illuminating devices such as light emitting diodes and incandescent lamps. In the preferred embodiment, vehicle display panel 100 comprises graphical display devices capable of displaying identifications of transit stops, input switches, and illuminating devices such as light emitting diodes and incandescent lamps.

In the preferred embodiment, transit select pushbuttons 64 are mechanical pushbuttons. In an alternate embodiment, targets on a touch panel overlay could implement transit select pushbuttons 64

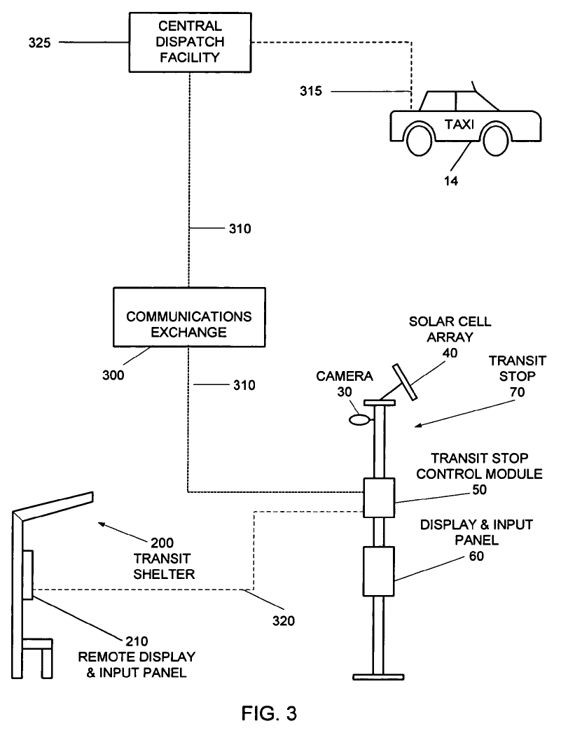

FIG. 3 illustrates an alternative or enhanced embodiment of a public transportation information system comprising a central dispatch facility 325 in communication with one or more roving transit vehicles 14 over communications link 315.

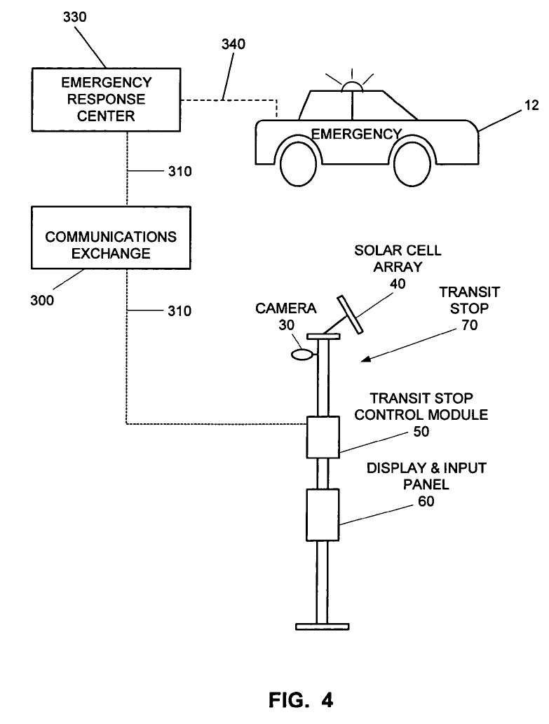

FIG. 4 depicts the communication links of transit stop 70 in communication with emergency response center 330. Emergency response center 330 communicates with emergency vehicle(s) 12 over emergency vehicle communication link 340 which may the same or different from the embodiment of transit stop communication link 310.

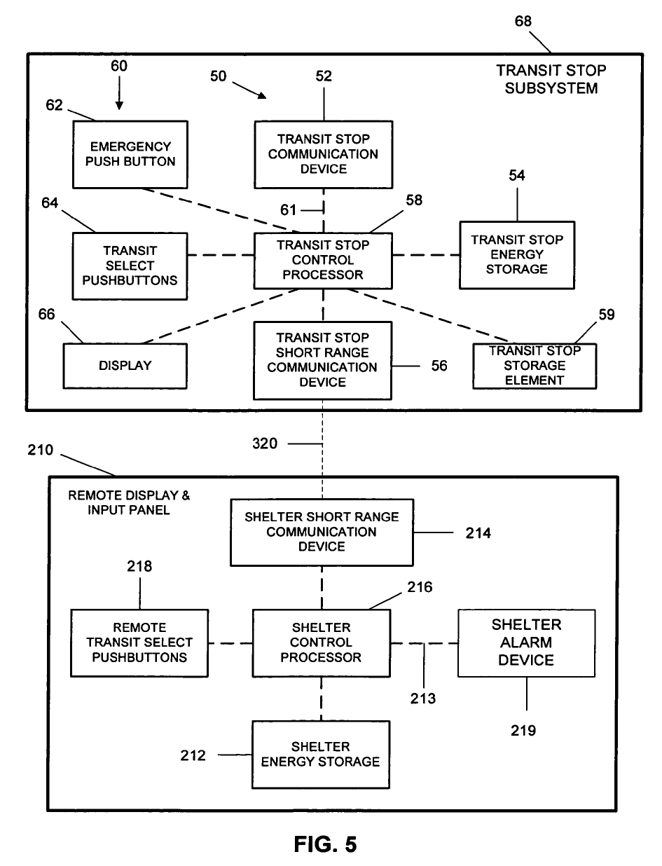

FIG. 5 depicts, a transit stop subsystem 68 comprising a transit stop control module 50 and display and input panel 60. Transit stop subsystem 68 is shown connected by shelter communication link 320, described above, to remote display & input panel 210. Remote display & input panel 210 comprises shelter energy storage 212, transit shelter short-range communication device 214, shelter control processor 216, remote transit select pushbuttons 218, shelter electrical connections 213, and shelter alarm device 219. Shelter alarm device 219 has provision for audible and visual outputs.

In the preferred embodiment transit stop short range communication device 214 is implemented with low power radio frequency, however in alternate embodiments it could comprise light sending and receiving devices such as infrared transmitters and receivers, or it could be a directly wired connection.

In the preferred embodiment, transit select pushbuttons 64 are mechanical pushbuttons. In an alternate embodiment, transit select pushbuttons 64 could be implemented as targets on a touch panel overlay to a display panel.

In the preferred embodiment shelter energy storage 212 is comprised of a battery, but could include power input from commercial power, a wired connection to transit stop 70 seen in FIG. 1, or by addition of a solar cell array (not shown).

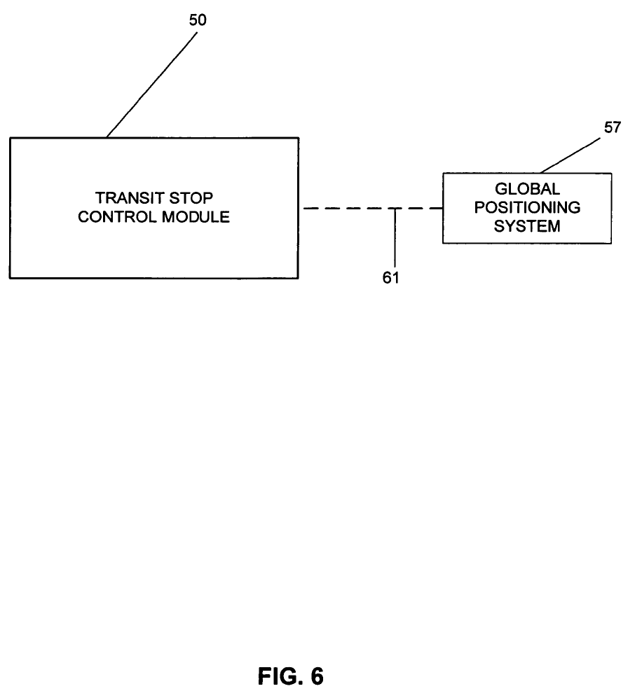

FIG. 6 depicts an alternate embodiment of transit stop control module 50, which further comprises a global positioning system 57.

FIG. 7 illustrates the incorporation of a shuttering device 520 depicted in its closed state, affixed to transit stop 70, to implement a means of blocking incident radiant energy 500 from striking reflector 540 on transit stop 70, thus eliminating any reflections to mass transit vehicle 10. The closed state of the shuttering device 520, is shown as being determined by the shutter control 530 linkage to the transit stop control module 50.

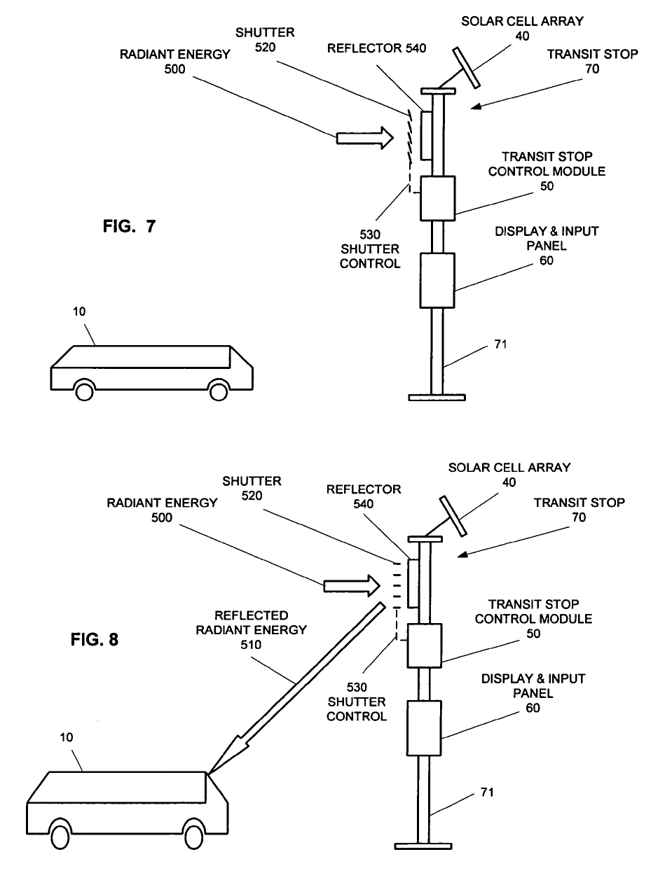

FIG. 8 illustrates the incorporation of a shuttering device 520 depicted in its open state, affixed to transit stop 70, to implement a means of passing incident radiant energy 500 through to reflector 540 on transit stop 70, thus providing reflections to mass transit vehicle 10. The open state of the shuttering device 520, is shown as being determined by the shutter control 530 linkage to the transit stop control module 50.

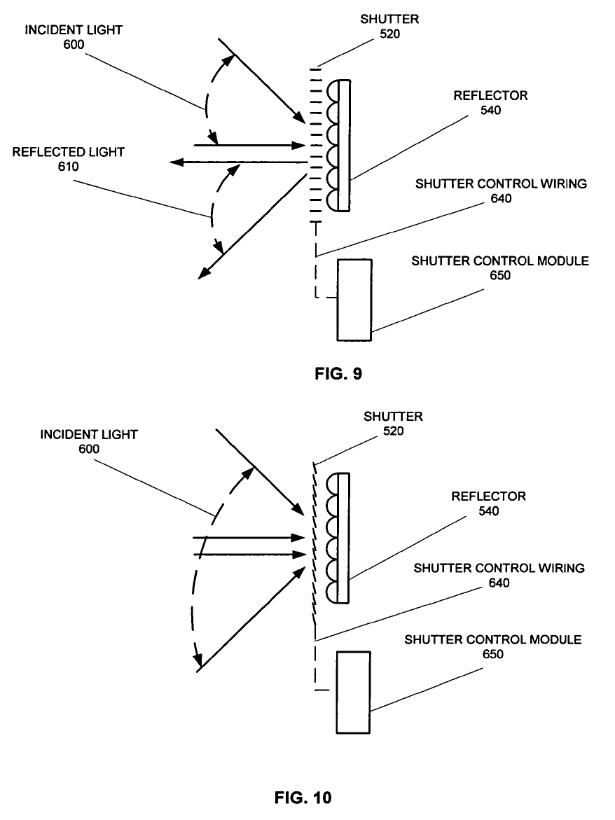

FIGS. 9 and 10 illustrates a signaling device comprising a reflector 540 having a shutter 520 interposed in its incident light path 600 and reflective light path 610. The open, light passing state, and closed, light blocking state, of shutter 520 are depicted as being set by a shutter control module 650's output electrical connection through shutter control wiring 640. In the preferred embodiment, shutter control module 650 further comprises a timing element, not shown, which causes shutter 520 to transition between its open and closed states at a predetermined rate.

In the preferred embodiment, incident radiant energy is visible light and shuttering device 520, comprises a suspended particle device, SPD, as recited in U.S. Pat. No. 6,301,040, a film that changes from transparent to opaque in response to applied electrical energy, and reflector 540 is a plurality of the common types of visible light reflectors as are normally used on street signs, street median markers, and bicycles fenders and caution signs. In an alternate embodiment, shuttering device 520 could be implemented by mechanical means having operation similar to a Venetian blind as is commonly used with ordinary windows. Although the preferred embodiment utilizes visible light and a light shuttering device, alternate embodiments could employ other forms of radiated energy such as sound or radio frequency with other means of reflecting and blocking said radiated energy. For instance, it is known in the art to emit radar waves and use their reflections to determine presence and or speed of vehicles, and it is known to employ means which block reflection of radar signals as are employed by military stealth aircraft.

### DESCRIPTION OF OPERATION

FIG. 2

In the preferred embodiment, vehicle processor and data storage device 90 communicates via vehicle communication device, 80, to query transit stops located at future points along the route traveled by its associated transit vehicle. Vehicle processor and data storage device 90 has memory storage to maintain a table of calling numbers and associate physical locations of the transit stops on its route, and the nominal travel time between successive stops.

Transit stop control processor 58 uses transit stop storage element 59 to maintain memory of selections of the specific route(s) desired by patrons, from their depressions of transit select pushbutton(s) 64. Vehicle processor & data storage 90 outputs to vehicle display panel 100, the locations of the transit stops called, having matches of patron selections to the transit vehicle route.

FIGS. 1, 2

At appropriate times, query calls are made from transit vehicle(s) 10 to future transit stop(s) 70, and patron selection data that corresponds to their respective routes is uploaded and estimated time(s) to arrive at the transit stop(s) called is downloaded. From query responses, vehicle processor & data storage 90 determines which transit stops have patrons waiting for its associated specific route, and presents this transit stop location data in visual form on vehicle display panel 100. Further, each query contains the route identifier of the transit vehicle initiating the call and a coded authorization identifier. When transit stop control processor 58 receives queries, it validates receipt of authorization identifications and transmits a list of its stored transit route requests that correspond to the route identities received in the queries. Transit stop control processor 58 provides acknowledgements to display panel 66 to inform the patron(s) when their selected routes have been queried, and the estimates of times until arrivals of the requested transit vehicles. Transit stop control processor 58 receipts of calls lacking authorization identification results in disconnect of the incoming call to prevent tying up the communication link 310. While the stored numbers of vehicle processor and data storage device 90 in a preferred embodiment, are telephone numbers, it can be appreciated that in an alternate embodiment they could implemented as IP addresses on an Internet link, or by other means on a radio frequency link.

FIGS. 2,4, 6

Emergency pushbutton 62 shown in FIG. 2 is implemented in a guarded secure manner to prevent accidental unwanted activation, and transit stop control processor 58 recognizes its intentional depression. Transit stop storage element 59 has memory storage of calling numbers of emergency response centers 330 seen in FIG. 4. Transit stop control module 58 initiates calls, to one or more emergency response centers upon activation of the emergency call pushbutton 62. In the preferred embodiment, as illustrated in FIG. 2, transit stop control module 50 has the physical location of its associated transit stop 70 stored in transit stop storage element 59, and transmits this location address in conjunction with all messages. In an alternate embodiment, as depicted in FIG. 6, transit stop control module 50 could include a global positioning system 57 for determining its physical location.

FIGS. 2,4

In the preferred embodiment, transit stop storage element 59 also contains a recorded voice message, which defines the message as being of an emergency type coming from the location of its associated transit stop. Transit stop control processor 58 responds to depression of emergency pushbutton 62, by retrieving the number for emergency calls stored in transit stop storage element 59, and activating transit stop communication device 52 to establish a communication link with an emergency response center 330. Upon transit stop control processor 58 detecting an emergency call being answered, it causes the recorded voice message to be communicated, after which two-way voice communication to the emergency response center 330 is facilitated by speaker 51 and microphone 53.

Provision is made to send video images from camera. 30, in addition to voice communication facilitated by microphone 53 and speaker 51. Means are well known in the teleconferencing art to include methodology for controlling video cameras attributes such as direction of orientation and viewing angle, concurrently with two-way transmission of audio. In the preferred embodiment transit stop control module 50 and camera 30 are responsive to teleconferencing type control signals. In the preferred embodiment, designated facilities such as the emergency response center 330 and central dispatching facilities 325, would have computers connected to communication link 310, through DSVD modems and could receive and transmit simultaneous data and voice. Computers connected with DSVD modems at emergency response center 330 or central dispatching facilities 325 could input and process data, acquire, display, and store images emanating from camera 30, and alter direction of imaging of camera 30 via control data sent over transit stop communication link 310. From analysis of the video and audio received, emergency response center 330 could communicate over emergency vehicle communication link 340 with appropriate emergency response vehicle(s) 12. In an alternate embodiment requiring enhanced security, encryption could be applied to any or all, sound, data and video images communicated from transit stop 70 prior to transmission, and receiving facilities would have capabilities for deciphering the encrypted communicated sound, video and data.

FIGS. 1, 3

FIG. 3 illustrates the capability of transit stop 70 to be used by patrons who request transport service through a central facility. FIG. 3 illustrates transit vehicle 14 as a roving vehicle, taxi, but, obviously, the same embodiment could be applied for mass transit vehicles 10 such as buses that have communications with a central facility. In this embodiment, display and input panel 60 comprises pushbuttons that provide selection of one or more providers of transit service. In the preferred operation of this embodiment, transit stop control processor 58 acquires from storage element 59, the call numbers of the central dispatch facilities 325, corresponding to pushbuttons of display panel 60, and by use of transit stop communication device 52, transit stop communication link 310 and communications exchange 300, establishes a communication link with the central facility 325 corresponding to the pushbutton depressed. Central dispatch facilities having computers capable of acquiring data and or images, can, in addition to the normal voice interaction with the patron calling, utilize these capabilities to determine the location of the call origin, and view and or store video images emanating from the call origin location. A record of both the video images of, and audio inputs from patrons requesting service could thus be maintained at the central dispatch facility as a means to discourage future crimes being perpetrated on drivers of transit vehicles. Central dispatch facility 325 is illustratively shown communicating with roving transit vehicle(s) 14, by way of communications link 315, to respond to patron requests initiated at transit stops 70. Central dispatch facilities 325, having means to transmit data, in addition to voice, on communications link 310, could provide data to transit stop control module 50 for output to display and input panel 60 relative to acknowledgment of the dispatch of transit vehicle 14 and the estimated arrival time, or time to arrive, for transit vehicle 14.

FIGS. 3,5

Also shown in FIGS. 3 and 5, is a redundant user interface implemented by remote display & input panel 210, located in shelter 200. Remote display and input panel 210, is connected to transit stop control module 50 of transit stop 70, by shelter communication link 320. Transit select pushbuttons on remote transit select pushbuttons panel 218 are functionally similar to transit select pushbuttons of display and input panel 60. In transit shelter 200, control processor 216 responds to depressions of pushbuttons on remote transmit select pushbuttons 218, and communicates pushbutton selections to transit stop control processor 58 by way of transit shelter short range communication device, 214, communications link 320 and transit stop short range communication device 56. In the preferred embodiment, shelter energy storage 212 comprises a battery. To conserve energy in shelter energy storage 212, shelter control processor 216 and shelter short range communication device 214 are in an inactive state until a pushbutton is depressed on the remote transmit select pushbutton 218 panel, whereupon they are activated for sufficient time to transfer selection data to transit stop control processor 58. Also in the preferred embodiment, shelter alarm device 219 comprises a sounding device and flashing illuminated device to indicate acknowledgements from transit vehicles. In alternate embodiments shelter energy storage device 212 could be replenished by commercial power, from inclusion of a solar charger or from power input from energy storage device 54 when shelter communication link 320 is implemented by direct-wired connections. In an alternate embodiment where energy is replenished, shelter control processor 216 and transit shelter short range communication device, 214 could-remain powered and pushbutton selection acknowledgements resulting in outputs to display 66 could be communicated to shelter control processor 216 to provide redundant output on shelter alarm device 219 for notifications to patrons of transit selection acknowledgements received from mass transit vehicles. In embodiments whereby transit shelter 200 has power replenished, shelter alarm device 219 could comprise a graphic display and remote transit select pushbuttons 218 could comprise a touch panel overlay.

FIGS. 7,8

FIGS. 7 and 8 illustrate the response of patron depression of pushbuttons located on Display and Input Panel 60, that are coupled to Transit Stop Control Module 50, which in turn activates shutter control 530 to set shutter 520 to the open, passing position, permitting incident Radiant Energy 500, to be reflected from Reflector 540 as Reflected Energy 510 to be observed by the driver of mass transit vehicle 10, as an indication that patrons are waiting for pickup. In the preferred embodiment, Control Module 50 comprises timing means to restore shutter 520 to the closed, blocking position after a preset time interval. In an alternate embodiment, communication from mass transit vehicle 10 to transit stop 70 could be employed as a means to cause control module 50 to activate shutter control 530 to set shutter 520 to the closed, blocking position.

FIGS. 9 and 10

FIGS. 9 and 10 show a signaling device comprising a shutter 520 located in the light path of a reflector 540. The open, light passing state of shutter 520 is shown by FIG. 9 as passing incident light 600 to produce reflected light 610 from reflector 540 and the closed state of shutter 520 is depicted by FIG. 10 as blocking incident light 600 from being reflected. The open and closed states of shutter 520 are determined by shutter control module 650's output electrical energy being connected by shutter control wiring 640 to shutter 520. In the preferred embodiment, shutter control module 650 comprises a timing element, not shown, which causes shutter 520 to transition to a closed state after a predetermined time, and/or to transition between the open and closed states at a predetermined rate, resulting in reflector 540 having the appearance of blinking on and off. Suitable timing elements capable of performing these functions are well known in the art, and include but are not limited to electrical circuits and microprocessors.

Although the foregoing specific details describe various embodiments of the invention, persons reasonably skilled in the art will recognize that various changes may be made in the details of the apparatus of this invention without departing from the spirit and scope of the invention as defined in the appended claims. Therefore, it should be understood that, unless otherwise specified, this invention is not to be limited to the specific details shown and described herein.

### Drawings—Reference Numerals

10 Mass transit vehicle
12 Emergency vehicle
14 Roving transit vehicle
20 Vehicle communication display module
30 Camera
40 Solar cell array
50 Transit stop control module
51 Speaker
52 Transit Stop Communication Device
53 Microphone
54 Transit Stop Energy storage
56 Transit stop short range communication device
57 Global positioning system
58 Transit stop Control processor
59 Transit stop storage element
60 Display and input panel
61 Transit stop electrical connections
62 Emergency pushbutton
64 Transit select pushbuttons
66 Transit stop display
68 Transit stop subsystem
70 Transit stop
71 Support platform
80 Vehicle communication device
90 Vehicle processor & data storage
95 Vehicle communication display module electrical connections
100 Vehicle Display panel
150 Public Transportation Information System
200 Transit shelter
210 Remote display and input panel
212 Shelter energy storage
213 Shelter electrical connections
214 Shelter short range communication device
216 Shelter control processor
218 Remote transit select pushbuttons
219 Shelter alarm device
300 Communication exchange
310 Transit stop communication link
320 Shelter communication link
315 Central dispatch to transit vehicle communication link
325 Central dispatch facility
330 Emergency response center
340 Emergency vehicle communication link
500 Radiant energy
510 Reflected radiant energy
520 Shutter
530 Shutter control
540 Reflector
600 Incident light
610 Reflected light
650 Shutter control module
640 Shutter control wing

1. A system for patrons at transit stops desiring transportation services to notify providers of said services with the locations of the transit stops from which said patrons are requesting said services, comprising:
a structural support at said transit stop locations;
a user interface supported by said structural support, the user interface operable to provide a input selection of available transportation services and enable said patrons to choose among said selections of said transportation services, and said user interface providing output to a display device;
a controller supported by said structural support, said controller communicatively coupled to said user interface and operable to process information identifying the location of said transit stop, said user selections, and said provider's communications;
a communications device communicatively coupled to said controller, said communications device operable to communicate said patron's selections to the providers of said services and said communications device operable to receive said provider's communicated responses to said patron's selections;
a energy sourcing device and a energy storage device supported by said structural support, operable to provide electrical energy to said transit stop.

2. The system according to claim 1 further including a communications device, and display device located in the transit vehicles, said vehicle communications device and display device being responsive to communications with said communication devices at said transit stops, and the vehicle communication device providing output information to the vehicle display device.

3. The system according to claim 2, the vehicle communications device providing communication authorization data when communicatively coupled to said transit stop locations.

4. The system according to claim 1 further comprising a solar power, generating device.

5. The system according to claim 1 further comprising a global positioning system, operable coupled to said controller to provide said locations of said transit stops.

6. The system according to claim 1 further including a communications device, and a display device located in one or more central dispatch facilities, said central dispatch communications device and said central dispatch display device being responsive to communications with the communication devices at said transit stops, and the communication device at said central dispatch facility providing output information to said display device at said central dispatch facility.

7. The system according to claim 6 further including means for simultaneous sound and data in communications between said central dispatch facilities and said transit stops.

8. The system according to claim 6 further comprising a video image capturing device, the video image capturing device being communicatively coupled to the controller at said transit stop, and said controller operable to communicate video images.

9. The system according to claim 8, including encryption of data communicated by said system.

10. The system according to claim 1 further comprising a second communications means at said transit stop, and including a transit shelter having communications means, and a user interface located within, said transit shelter communications means being communicatively coupled with said second communication means at said transit stop, and said shelter user interface communicatively coupled to said shelter communication means, and operable to provide a input selection of available transportation services and enable said patrons to choose among said selections of said transportation services; and said shelter user interface providing output to a display device.

11. A system operable to provide voice and data communications between providers of emergency services and people at designated locations desiring to communicate with said providers of emergency services comprising:
a structural support at said locations;
a input device supported by said structural support operable to indicate desire for communication with said providers of emergency services;
a controller supported by said structural support, said controller responsive to said input device, and operable to store data comprising pre-recorded sound and information defining the location of the support; said controller further operable to provide said stored data for communication to said providers of emergency services when said providers of emergency services are communicatively coupled to said support locations;
a communications device communicatively coupled to said controller, said communications device operable to communicate with said providers of emergency services;
a energy sourcing device and a energy storage device supported by said structural support, operable to provide electrical energy to said system.

12. The system according to claim 11, said energy sourcing device further comprising a solar power generating device.

13. The system according to claim 11 further comprising a global positioning system, operable coupled to said controller to provide said locations of said structural supports.

14. The system according to claim 11 further comprising:
a video image capturing device providing video image data and communicatively coupled to the controller at said designated location, and said controller operable to communicate video image data;
means for combining sound and data in communications between said providers of emergency services and said people at said designated locations.

15. A transportation signaling system comprising:
a structural support at a transit location;
a reflecting device attached to said structural support, said reflecting device capable of reflecting radiant energy;
a shuttering device having a first state to block radiant energy and a second state to pass radiant energy, said shuttering device located in the radiant energy path of the reflecting device; and
a user interface communicatively coupled to the shuttering device and operable to enable a person at the transit location to activate the shuttering device.

16. The transportation signaling system of claim 15, further comprising a solar energy collector mounted on the structural support, the solar energy collector collecting energy for use in powering the shuttering device.

17. The transportation signaling system of claim 15 further comprising a timing element interposed between the user interface and the shuttering device operable to cause the shuttering device of claim 15 to alternate between the states of blocking or passing radiant energy.

18 The transportation signaling system of claim 15 further comprising a timing element operable to cause the shuttering device of claim 15 to transition to a blocking state after a preset time interval.

19. The transportation signaling system of claim 15 wherein the shuttering device comprises an electrically-sensitive medium that alters the amount of radiant energy that can pass through said medium in response to electrical energy applied to said medium.

20. A signaling device comprising:
a reflecting member, said reflecting member capable of reflecting light;
a shuttering device comprising a medium that alters the amount of light passing through said medium, in response to electrical energy applied to said medium, said shuttering device positioned in the light path of the reflecting device; and
a control element operable to supply variable electrical energy to said shuttering device.
